(19) United States
(12) Patent Application Publication
(10) Pub. No.: US 2013/0029528 A1
(43) Pub. Date: Jan. 31, 2013

(54) CONNECTOR WITH LIGHT SOURCE AND ELECTRONIC APPARATUS USING THE SAME

(71) Applicant: AN-GANG LIANG, Shenzhen City (CN)

(72) Inventor: AN-GANG LIANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/223,273

(22) Filed: Aug. 31, 2011

(30) Foreign Application Priority Data
Jul. 25, 2011 (CN) 201110208902.0

(51) Int. Cl. H01R 13/717

(52) U.S. Cl. 439/620.21

(57) ABSTRACT

A connector for connecting a peripheral device to a electronic apparatus includes a shell defining an opening therein, and a light source received in the opening capable of illuminating surroundings. The light source is powered by the connector. The connector further includes a power pin and a ground pin, and the light source is connected to the power pin and the ground pin.

### BACKGROUND

1. Technical Field

The present disclosure relates to a connector, and particularly, to a connector with a light source.

2. Description of Related Art

The need to use connectors such as Universal Serial Bus (USB) connectors with electronic devices is common. However, in dark environments, it is difficult for users to locate and use such connectors.

Therefore, what is needed is a connector with a light source that overcomes the above-mentioned problem.

### BRIEF DESCRIPTION OF THE DRAWINGS

The components in the drawings are not necessarily drawn to scale, the emphasis instead being placed upon clearly illustrating the principles of a connector with a light source. Moreover, in the drawings, like reference numerals designate corresponding parts throughout the several views.

FIG. 1 is an isometric view of a connector in accordance with an exemplary embodiment.

FIG. 2 is a circuit diagram of the connector of FIG. 1

FIG. 3 is an isometric view of a computer installed with the connector of FIG. 1 in accordance with another exemplary embodiment.

FIG. 4 is an enlarged view of a circled portion III of FIG. 2.

### DETAILED DESCRIPTION

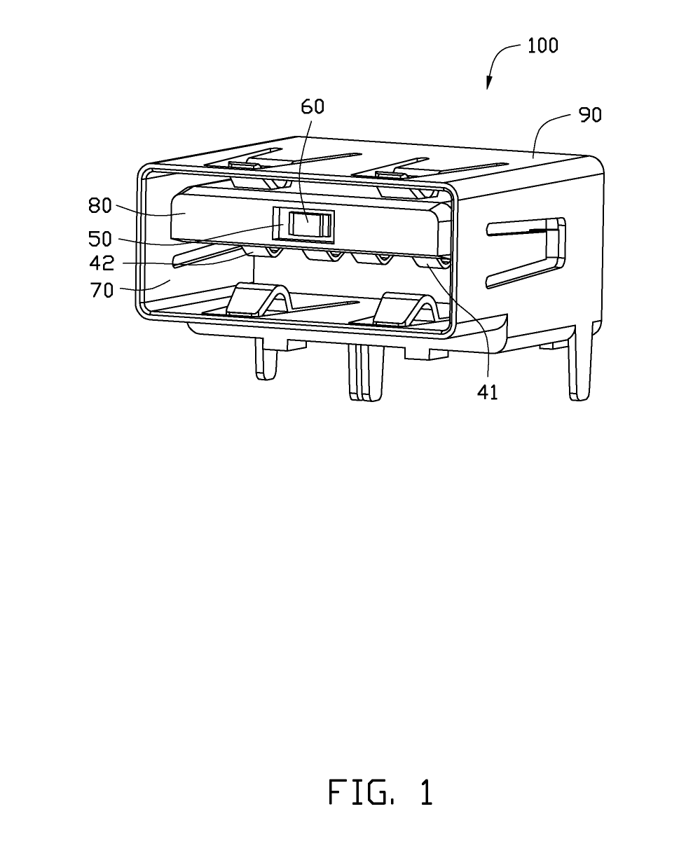

Referring to FIG. 1, a connector 100 includes a shell 90, a pin base 80, and a light source 60. In the present embodiment, the connector 100 is a Universal Serial Bus (USB) connector.

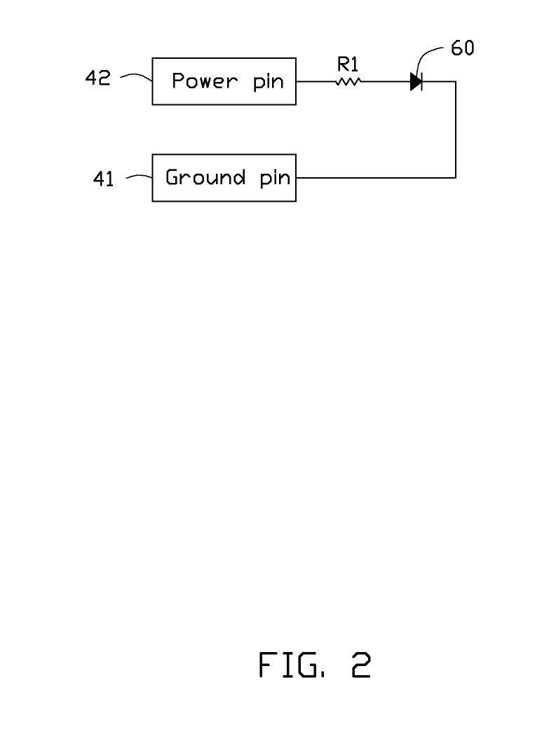

The shell 90 defines a chamber 70 surrounded by a top wall, a bottom wall, and two sidewalls of the shell 90. The pin base 80 is set in the chamber 70 adjacent to the top wall of the shell 90. An opening 50 is defined in a front side of the pin base 80, and the light source 60 is received in the opening 50. A ground pin 41 and a power pin 42 are arranged on the bottom of the pin base 80. In the present embodiments, the light source 60 is a light emitting diode (LED) lamp, and referring to FIG. 2, an anode of the light source 60 is connected to the power pin 42 through a resistor R1 while a cathode of the light source 60 is connected to the ground pin 41. In other embodiments, the light source 60 can be a light bulb, and the anode can be directly connected to the power pin 42.

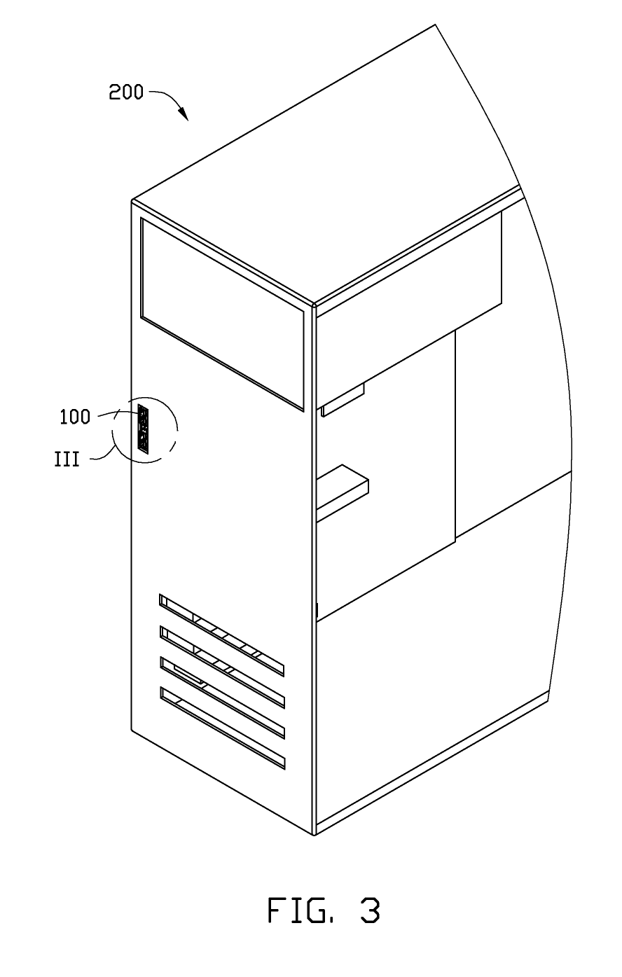

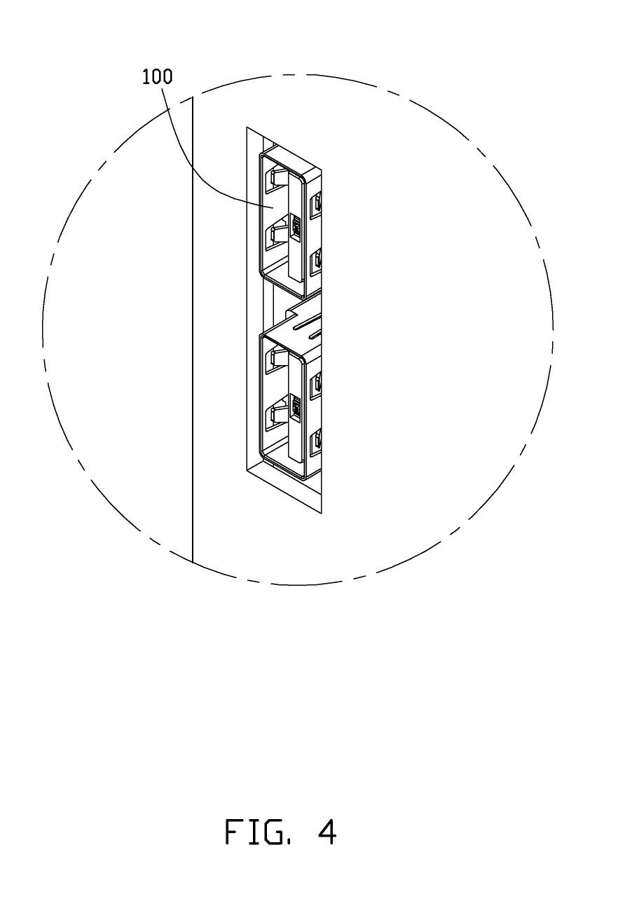

Referring to FIGS. 3-4, the connector 100 is installed on an electronic apparatus 200, and a power circuit (not shown) of the electronic apparatus 200 supplies power to the power pin 42 of the connector 100 which powers the light source 60. Therefore, when the electronic apparatus 200 is switched on, the light source 60 turns on and provides light to the user to connect a peripheral device (not shown) to the connector 100 even in a dark environment. In the present embodiment, the electronic apparatus 200 is a computer.

Although the present disclosure has been specifically described on the basis of this exemplary embodiment, the disclosure is not to be construed as being limited thereto. Various changes or modifications may be made to the embodiment without departing from the scope and spirit of the disclosure.

What is claimed is:

1. A connector for connecting a peripheral device to an electronic apparatus, comprising:
a shell defining an opening therein; and
a light source received in the opening capable of illuminating surroundings, wherein the light source is powered by the connector.

2. The connector as claimed in claim 1, further comprising a power pin and a ground pin, wherein the light source is connected to the power pin and the ground pin.

3. The connector as claimed in claim 2, wherein a pin base is arranged in the opening, and the power pin and the ground pin are arranged on the pin base.

4. The connector as claimed in claim 3, wherein the light source is arranged on a front side of the pin base of the connector.

5. The connector as claimed in claim 2, wherein the light source is a Light Emitting Diode (LED), and an anode and a cathode of the LED is connected to the power pin and the ground pin of the connector, respectively.

6. The connector as claimed in claim 1, wherein the connector is a Universal Serial Bus (USB) connector.

7. An electronic apparatus, comprising:
a connector comprising a shell defining an opening therein, and a light source received in the opening capable of illuminating surroundings, wherein the light source is powered by the connector.

8. The electronic apparatus as claimed in claim 7, wherein the connector comprises a power pin and a ground pin, and the light source is connected to the power pin and the ground pin.

9. The electronic apparatus as claimed in claim 8, wherein a pin base is arranged in the opening, and the power pin and the ground pin are arranged on the pin base.

10. The connector as claimed in claim 9, wherein the light source is arranged on a front side of the pin base of the connector.

11. The electronic apparatus as claimed in claim 8, wherein the light source is a Light Emitting Diode (LED), and an anode and a cathode of the LED is connected to the power pin and the ground pin of the connector, respectively.

12. The electronic apparatus as claimed in claim 8, wherein the power pin and the ground pin is connected to a power circuit of the electronic apparatus to power the light source.

13. The electronic apparatus as claimed in claim 7, wherein the connector is a Universal Serial Bus (USB) connector.
